(19) United States
(12) Patent Application Publication
(10) Pub. No.: US 2025/0165702 A1
(43) Pub. Date: May 22, 2025

(54) INFORMATION PROCESSING DEVICE, COMPUTER-READABLE MEDIUM, AND INFORMATION PROCESSING METHOD

(71) Applicant: LegalOn Technologies, Inc., Tokyo (JP)

(72) Inventors: Manabu NAKANO, Tokyo (JP); Yuta KURODA, Tokyo (JP); Wei Hong HO, Tokyo (JP)

(21) Appl. No.: 19/028,760

(22) Filed: Jan. 17, 2025

Related U.S. Application Data
(63) Continuation of application No. PCT/JP2023/013739, filed on Mar. 31, 2023.

(30) Foreign Application Priority Data
Jul. 20, 2022 (JP) 2022-115916

(51) Int. Cl. G06F 40/166; G06Q 50/18

(52) U.S. Cl. CPC G06F 40/166; G06Q 50/18

(57) ABSTRACT

An information processing device according to an embodiment includes at least one processor. the at least one processor is configured to: transmit, to a terminal device, an instruction to cause the terminal device to display first document data that has been saved and review information of the first document data with positionally associated with each other; generate editing data based on the first document data; and edit the editing data in response to an editing instruction received from the terminal device.

### CROSS-REFERENCE TO RELATED APPLICATIONS

This application is a continuation of International Application No. PCT/JP2023/013739, filed on Mar. 31, 2023 which claims the benefit of priority of the prior Japanese Patent Application No. 2022-115916, filed on Jul. 20, 2022, the entire contents of which are incorporated herein by reference.

### FIELD

Embodiments of the present disclosure relate to an information processing device, a computer-readable medium, and an information processing method.

### BACKGROUND

In the related art, for example, there is a technique for supporting creation of an XML document on a web browser.

A related technique is described in JP 2014-167797 A.

### SUMMARY

An information processing device according to an embodiment includes at least one processor. The at least one processor is configured to: transmit, to a terminal device, an instruction to cause the terminal device to display first document data that has been saved and review information of the first document data with positionally associated with each other; generate editing data based on the first document data; and edit the editing data in response to an editing instruction received from the terminal device.

### BRIEF DESCRIPTION OF THE DRAWINGS

FIG. 1 is a schematic diagram for describing an outline of a document creation support system according to an embodiment;

FIG. 2 is a block diagram illustrating an example of a hardware configuration of an information processing device according to an embodiment;

FIG. 3 is a diagram illustrating an example of functional blocks in a processor of the information processing device according to the present embodiment;

FIG. 4 is a block diagram illustrating an example of a hardware configuration of a terminal device according to the embodiment;

FIG. 5 is a diagram illustrating an example of functional blocks in a processor of the terminal device according to the embodiment;

FIG. 6 is a diagram illustrating an example of a document review screen displayed on a display of a terminal device in the document review process according to the embodiment;

FIG. 7 is a diagram illustrating an example of a document editing screen displayed on a display of a terminal device in a document editing process according to the embodiment; and

FIG. 8 is a flowchart illustrating a flow of a document creation support process according to the embodiment.

### DETAILED DESCRIPTION

Hereinafter, embodiments will be described in detail with reference to the drawings. Note that, in the following description, constituent elements having substantially the same functions and configurations are denoted by the same reference numerals, and description will be made when necessary. In addition, the embodiment can be combined with other embodiments, modifications, and conventional techniques.

In a document creation supporting technique on a web browser, there is no known technique for editing a document while viewing a result of document review. In addition, for example, in a case where document creation is performed using document creation software on a user's personal computer without using a web browser, it is necessary to display and operate a file for document review and a file for editing side by side. Therefore, there is room for further improvement in terms of user's operation burden and convenience.

A problem to be solved by the present disclosure is to provide a highly convenient technique when supporting document creation based on a review result on a web browser.

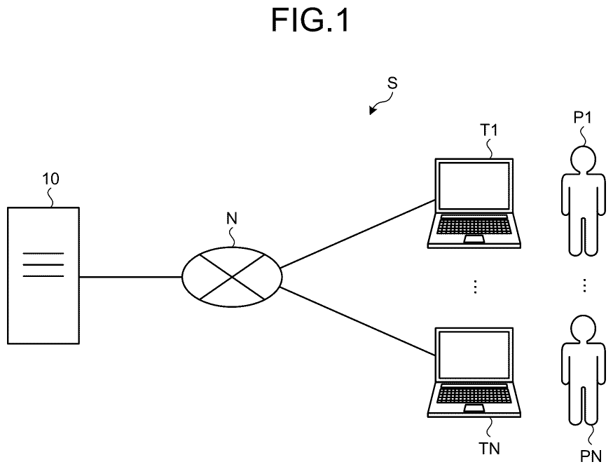

FIG. 1 is a schematic diagram for describing an outline of a document creation support system S according to the present embodiment. As illustrated in FIG. 1, the document creation support system S may function as a document creation support system, and include, for example, an information processing device 10 and at least one terminal device T1 to TN that can communicate with the information processing device 10 according to the embodiment via a network N. The terminal devices T1 to TN may be operated by the users P1 to PN, respectively. Note that the terminal devices T1 to TN will be described by taking the configuration of the terminal device T1 as an example.

Here, the document creation support system S may be a system that supports document creation on the browser. In the present specification, a document may mean a document in any language created according to a certain rule or standard, for example, a certain regulation, law, custom, or the like. In the present specification, the document data may mean information obtained by converting a document into data in an editable manner by document creation software regardless of a data format. The document data may be typically text data, but may also include data such as image data, tabular data, and the like. In addition, the document or the document data may include meta information (version, creation date, update date, creator, updater, etc.), format information (decoration such as underline and marker, font, indent, and the like), change history information, comment information, and the like created by document creation software as necessary.

Hereinafter, for specific description, a case where the document handled by the document creation support system S is a legal document (for example, a contract document) in Japanese will be described as an example. However, the document handled by the document creation support system S is not limited to the contract document, and is not limited to the Japanese document. For example, it may be company regulations in English.

In the present specification, the document creation support service may be a service including at least any one of executing a document review process on a document to be supported on a web browser and providing a result thereof to a user, executing document editing in response to an instruction from the user, saving an edited document or providing it to the user, editing additional information (for example, meta information, comment information, chat information, format information, and the like) associated with the document to be supported, creating a new document (including copying), comparing a plurality of documents (for example, clearly indicating difference information), and automatically proofreading and editing the document to be supported.

Note that, in the present specification, the document review process may be a process of analyzing or evaluating information included in a document to be supported based on a certain criterion and outputting a result thereof. For example, the document review process may be a process including checking and examining whether information included in a document to be supported is appropriate based on a certain criterion. Specifically, the process may include matching words in the document with a check list prepared in advance, and outputting a result of the matching or an indication included in the check list. Furthermore, editing may mean adding, deleting, or changing information included in the object to be edited.

The meta information associated with the document to be supported may include, for example, at least one of a document ID, a type of document (for example, a type of a basic transaction agreement, a non-disclosure agreement, an outsourcing agreement, or the like), a version, a creation date and time, an update date and time, an upload date and time, a creator, an updater, a deadline, and a document ID of a related document.

The comment information associated with the document to be supported of the present embodiment may be additional information created by at least one user related to creation of the document, and may be associated and managed for each version of the document to be supported, for example. The comment information associated with the document to be supported may be typically information different from the comment created by the document creation software, but may include a comment created by the document creation software as necessary.

The chat information of the present embodiment may be additional information generated using the chat function among a plurality of users related to creation of the document to be supported, and may be managed in association with, for example, a plurality of versions of the document to be supported. The additional information may be typically text data, but may also include other data formats such as an image, an audio, and the like.

The document to be supported in the present embodiment may be a document file uploaded from a terminal device, may be a file newly created on an online editor, or may be a file already uploaded and saved and/or edited.

The terminal device T1 may be a client device managed by the user P1 who uses the document creation support service. The terminal device T1 may display the document review result and the editing data with positionally associated with each other on the screen of the display device based on the information from the information processing device 10. In the present embodiment, the user can perform operations such as the document review reference, the comment input, the comment reference, the chat information input, the chat information reference, the document editing process, and the document saving on the document to be supported using the document review result displayed on the screen of the display device of the terminal device T1 and the editing screen.

Next, specific configurations of the information processing device 10 and the terminal device T1 of the present embodiment will be described.

### Information Processing Device 10

The information processing device 10 of the present embodiment may be a device that is connected to a client device by communication and performs various types of processing in response to a request from the client device. For example, the information processing device 10 may be a server device managed by a provider that provides a document creation support service. The information processing device 10 may provide a document creation support service to the terminal device T1 in response to a document creation support request received from the terminal device T1 as a client device via the network N. Specifically, the information processing device 10 according to the present embodiment may execute the document review process on a document in the document creation support service. Furthermore, the information processing device 10 may execute the document editing process in the document creation support service.

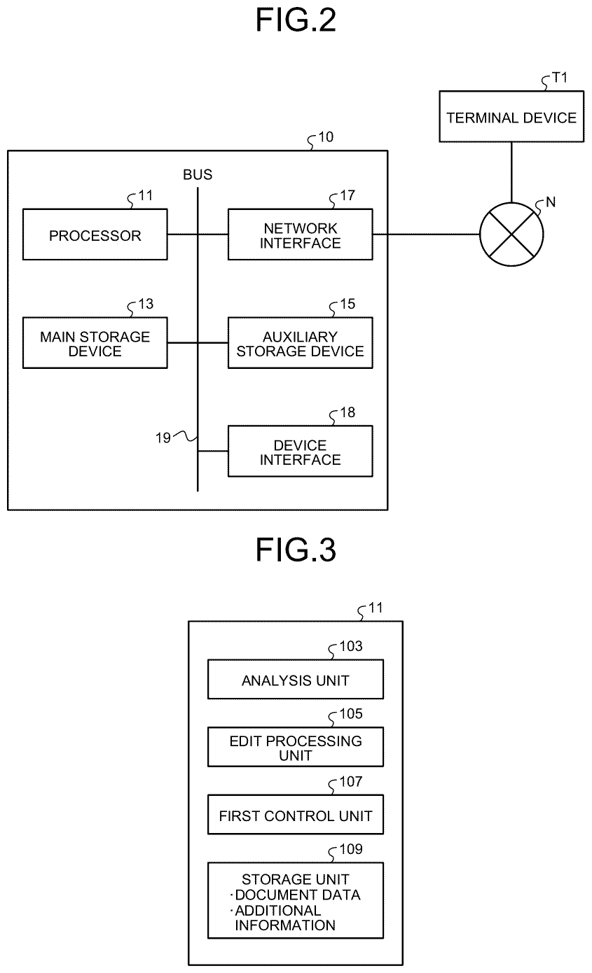

FIG. 2 is a block diagram illustrating an example of a hardware configuration of the information processing device 10 according to the embodiment. As illustrated in FIG. 2, the information processing device 10 may be a computer, and include, as an example, a processor 11, a main storage device (memory) 13, an auxiliary storage device (memory) 15, a network interface 17, a device interface 18, and a bus 19 that connects each component.

The information processing device 10 illustrated in FIG. 2 includes respective components by one, but may include a plurality of the same components. Furthermore, although FIG. 2 illustrates one information processing device 10, software may be installed in a plurality of computers, and each of the plurality of computers may execute the same or different processing of the software. In this case, there may be a form of distributed computing in which respective computers communicate with each other via the network interface 17 or the like to execute processing. That is, the information processing device 10 according to the present embodiment may be configured as a system that realizes various functions described later by one or a plurality of computers executing commands stored in one or a plurality of storage devices.

Various operations of the information processing device 10 may be executed in parallel processing using one or a plurality of processors or using a plurality of computers via a network. In addition, various operations may be distributed to a plurality of arithmetic cores in the processor and executed in parallel processing. Furthermore, some or all of the processing, units, and the like of the present disclosure may be executed by at least one of a processor and a storage device provided on a cloud communicable with the information processing device 10 via a network. As described above, the processing of the document creation support system S in the present embodiment may be in the form of parallel computing by one or a plurality of computers.

The processor 11 may be an electronic circuit (a process circuit, a processing circuit, a processing circuitry, a central processing unit (CPU), a graphics processing unit (GPU), a field programmable gate array (FPGA), an application specific integrated circuit (ASIC), or the like) including a control device and an arithmetic device of the information processing device 10. Furthermore, the processor 11 may be a semiconductor device or the like including a dedicated processing circuit. The processor 11 is not limited to an electronic circuit using an electronic logic element, and may be realized by an optical circuit using an optical logic element. Furthermore, the processor 11 may include an arithmetic function based on quantum computing.

The processor 11 can perform arithmetic processing based on data or software (program) input from each device or the component of the information processing device 10 to output an arithmetic result or a control signal to each device or the like. The processor 11 may control each component comprising the information processing device 10 by executing an operating system (OS), an application, or the like of the information processing device 10.

The information processing device 10 in the present embodiment may be realized by one or a plurality of processors 11. Here, the processor 11 may refer to one or more electronic circuits disposed on one chip, or may refer to one or more electronic circuits disposed on two or more chips or two or more devices. When a plurality of electronic circuits is used, the electronic circuits may communicate in a wired or wireless manner.

The main storage device 13 may be a storage device that stores commands executed by the processor 11, various pieces of data, and the like, and information stored in the main storage device 13 is read by the processor 11. The auxiliary storage device 15 may be a storage device other than the main storage device 13. Note that these storage devices may mean any electronic components capable of storing electronic information, and may be semiconductor memories. The semiconductor memory may be a volatile memory or a nonvolatile memory. The storage device for storing various pieces of data used in the information processing device 10 according to the present embodiment may be realized by the main storage device 13 or the auxiliary storage device 15, or may be realized by a built-in memory built in the processor 11. For example, the storage unit in the present embodiment may be realized by the main storage device 13 or the auxiliary storage device 15.

A plurality of processors may be connected (coupled) or a single processor 11 may be connected to one storage device (memory). A plurality of storage devices (memories) may be connected (coupled) to one processor. In a case where the information processing device 10 according to the present embodiment may include at least one storage device (memory) and a plurality of processors connected (coupled) to the at least one storage device (memory), at least one processor among the plurality of processors may be connected (coupled) to the at least one storage device (memory). Furthermore, this configuration may be implemented by storage devices (memory) included in a plurality of computers and the processor 11. Further, a storage device (memory) may be integrated with the processor 11 (for example, a cache memory including an L1 cache and an L2 cache).

The network interface 17 may be an interface that connects to the network N wirelessly or by wire. As the network interface 17, an appropriate interface such as one conforming to an existing communication standard may be used. The network interface 17 may exchange information with an external device connected via the network N. Note that the network N may be any of a wide area network (WAN), a local area network (LAN), a personal area network (PAN), or the like, or a combination thereof, as long as information is exchanged between the information processing device 10 and an external device. An example of the WAN includes the Internet, an example of the LAN includes IEEE 802.11 and Ethernet (registered trademark), and an example of the PAN includes Bluetooth (registered trademark) and near field communication (NFC).

The device interface 18 may be an interface such as a Universal Serial Bus (USB) directly connected to an output device such as a display device, an input device, and an external device. Furthermore, the external device may be a storage device (memory), a network storage, or a storage such as an HDD. Furthermore, the external device may be a device having some functions of the components of the information processing device 10 in the present embodiment. That is, the information processing device 10 may transmit or receive part or all of the processing result of the external device.

FIG. 3 is a diagram illustrating an example of functional blocks in the processor 11. The processor 11 may include, for example, an analysis unit 103, an edit processing unit 105, a first control unit 107, and a storage unit 109 as functions realized by the processor 11. The functions implemented by the analysis unit 103, the edit processing unit 105, the first control unit 107, and the storage unit 109 may be stored as programs in, for example, the main storage device 13 or the auxiliary storage device 15. The processor 11 can implement functions related to the analysis unit 103, the edit processing unit 105, the first control unit 107, and the storage unit 109 by reading and executing a program stored in the main storage device 13, the auxiliary storage device 15, or the like.

The analysis unit 103 of the present embodiment may execute the document review process using the document data (an example of the first document data) of the document to be supported received from the terminal device T1. That is, the analysis unit 103 may generate document review information to be described later regarding the document data as the document review process. Note that the document review information is an example of the analysis information.

The analysis unit 103 may extract, for example, information that is included in a document (document data) and is necessary for generating review information. Various techniques can be used as a method of extracting information from document data. For example, a keyword search of document data may be performed to extract a character, a number or the like included in the vicinity of the keyword. Furthermore, information can be extracted by morphological analysis, syntax analysis, semantic analysis, or context analysis. Furthermore, information may be extracted by natural language processing using machine learning. In addition, prior to these processes, information necessary for document review such as text data may be extracted from the received document data, or processing of extracting text data from image data may be performed by processing such as OCR. Note that the document review process may be performed on the received document without extracting information necessary for generating the document review information as described above.

The analysis unit 103 may perform the document review process and generate document review information. The document review information may be based on information obtained by analyzing the document based on a rule or standard applied to the document (for example, a certain regulation, law, convention). For example, the review information of the contract document as in the present embodiment can include (1) indication as to whether the clauses included in the document (the contract document in the present embodiment) are advantageous or disadvantageous to the user (party), (2) advice regarding modification and deletion of the clauses included in the contract document, (3) indication that the items usually included in the contract document are missing, and suggestion of the items to be added, and (4) information about the importance and the degree of recommendation of the items of each review result. In addition, format information such as whether the format of the sentence meets the standard, and whether a prescribed term is used may also be included.

Note that the generation of the document review information executed by the analysis unit 103 can adopt various techniques. For example, the document review information may be generated on a rule basis using the extracted information. In addition, it is also possible to use a learned model that receives the extracted information as an input to output the corresponding document review information. Furthermore, it is also possible to adopt a combination of a rule-based method and a learned model. In addition, before the generation of the document review information, the document may be divided into articles, sections, or items in units.

Furthermore, the analysis unit 103 can generate document review information according to the position of the user (party) using the meta information associated with the document to be supported. Furthermore, the analysis unit 103 can also generate the document review information with reference to content of another document (another version of the document to be supported, another contract document relevant to the document to be supported, and the like). The meta information may include one given to a document file itself such as a creator of the document and one given by a user or the like by being input separately from the file.

The edit processing unit 105 of the present embodiment may convert the data format of the document to be supported (document data) received via the first control unit 107 to generate editing data. For example, the edit processing unit 105 may convert the document data in the “DOCX” format received via the first control unit 107 into the “JSON” format and generates editing data.

In addition, the edit processing unit 105 of the present embodiment may execute the editing process on the editing data in response to the editing instruction received from the terminal device T1 via the first control unit 107. Here, the editing process executed by the edit processing unit 105 may include adding, deleting, and changing information included in the editing data. More specifically, addition, modification, and deletion of a word, a sentence, and a character decoration (for example, a font, a color of a character, a size of a character, a thickness of a character, an underline, a strikethrough, or the like) with respect to the editing data may be included.

Furthermore, the editing process executed by the edit processing unit 105 can include a format editing process, a word input assistance process, a draft suggestion process, a pointed out item extraction process, and a difference information extraction process.

Here, the format editing process may be a process of modifying the format of the editing data as a document. For example, indentation, the line head of itemized writing, right-alignment/left-alignment, deviation of the clause number, and the like are preferably automatically modified by the system by the format editing process. The edit processing unit 105 may refer to, for example, format information of the document to be supported corresponding to the editing data, and may execute the format editing process on the editing data based on the format information. In addition, the setting of the format as the document may be preferably stored in the information processing device 10 in advance based on the type of the document to be supported such as the contract document. For example, in the case of a legal document such as a contract document or company regulations, the articles may be disposed in the order of articles, sections, and items in the ascending order of the article numbers, and the indentation may be set to be larger in the order of articles, sections, and items. Furthermore, the edit processing unit 105 can execute the format editing process according to the type based on the meta information of the document to be supported. Note that this format setting may be created by the user, may be provided as part of the document creation support service, or may be created by the user customizing the provided setting. In addition, the format setting of the document to be supported may be interpreted, and the document to be supported may be created based on the interpretation.

The word input assistance process of the present embodiment may be a process of assisting input by presenting a candidate word or phrase to be input next at the time of editing document data. As a result, it is possible to support the user's input operation at the time of editing and reduce the work load. For example, words and the like that frequently appear according to the type of the document to be supported can be presented as input candidates. In addition, the document to be supported stored by the user or an organization to which the user belongs may be analyzed, and a word or the like that is often used may be presented. Furthermore, the user may set a word or a phrase. The edit processing unit 105 can determine the input candidate word according to the type based on the meta information of the document to be supported. The word and the like presented in the input assistance process may be displayed, for example, in a left window (in a document editing window) of a screen to be described later.

The draft suggestion process of the present embodiment may be a process of displaying a draft of an input candidate at the time of editing. For example, in a case where the document is a contract document, a modified sentence example based on at least part of a modification content of the contract document may be read from a database in which a text draft sentence example is accumulated and presented as a draft candidate. As a result, it is possible to support the user's input operation at the time of editing and reduce the work load.

The edit processing unit 105 may present a predetermined draft candidate, may present a draft candidate determined by the user or the provider of the document creation support service, may present a draft candidate generated by a sentence generation service in or outside the present system using a large language model (LLM) or the like, or may present a draft candidate that frequently appears according to the type of the document to be supported. Furthermore, a document to be supported stored by the user or an organization to which the user belongs may be analyzed to present a draft candidate that is more frequently used than other documents. In a case where there is a plurality of sentence example candidates, at least one draft candidate can be selected further based on an adoption rate (a rate at which a proposed text is selected by the user) of a text in the past document creation support service and an adoption frequency, and a candidate with a high adoption rate can be preferentially presented to the user. Note that the draft candidate to be presented can be presented as, for example, document review information or other information.

The edit processing unit 105 can also edit the editing data in response to the editing instruction based on the presented draft candidate, for example, an instruction by a drag and drop operation. The proposed draft may be displayed in a document review area or the like to be described later with being positionally associated with the corresponding portion of the document. For example, the draft candidate may be displayed close to the corresponding portion of the document. With such display, it is possible to compare and see the draft candidate and the corresponding portion of the document in such a manner with a small movement of the line of sight, and it is possible to reduce the burden on the user.

The pointed out item extraction process according to the present embodiment may include extracting a pointed out item (for example, document review information about the document data corresponding to the editing data, comment information, chat information, a correction history for the editing data, a comment of the document data created by the function of the document creation software, and the like) regarding at least one of editing data and document data corresponding to the editing data, and presenting them to the user. The edit processing unit 105 of the present embodiment may present the extracted pointed out items to the user in a predetermined display form. The pointed out items are preferably listed in an area that does not overlap with the portion of the document pointed out by the pointed out item, for example, a document review area 62 aligned with an editing area 61B, an independent (individual) window such as a pop-up window.

In addition, a combination of the pointed out item extraction process and the draft suggestion process may be used to propose a pointed out item and a draft candidate that can resolve the pointed out item. At this time, it may be preferable that the pointed out item and the draft candidate are displayed with positionally associated with the pointed portion of the document. For example, it may be preferable that the pointed out item and the draft candidate are displayed close to the corresponding pointed out item. With such display, it is possible to compare the pointed out item and the draft candidate with the corresponding portion of the document with a small movement of the line of sight, and it is possible to reduce the burden on the user.

Furthermore, folding display, minimization display, change in display size, and the like can be executed for the document review area 62, the pop-up window, and the like in which the pointed out item and the draft candidate are displayed. As a result, the user can arrange a document editing screen 60B having a limited size so as to be easily viewed by the user, for example, in alignment with the pointed portion of the document. In addition, based on the height of the pointed out item or the draft candidate, the texts may be displayed at a wider interval therebetween on the editing area 61B. With such display, it is possible to more clearly and easily indicate the correspondence relationship between the pointed out item and the draft candidate, and the pointed portion of the document.

The difference information extraction process of the present embodiment may present difference information between the editing data before modification and the editing data after modification to the user. The edit processing unit 105 of the present embodiment may extract difference information from the editing data before modification and the editing data after modification, and may present the difference and the portion other that the difference (that is, the same portion) to the user in a predetermined display form, for example, by displaying the difference and the other portion differently, for example, by emphasizing display or highlighting.

The edit processing unit 105 of the present embodiment may execute the above-described various editing processes in response to the editing instruction received from the terminal device T1. In addition, the edit processing unit 105 of the present embodiment may convert the data format of the editing data in response to the save instruction received from the terminal device T1, and may generate the document data to be the next version of the document to be supported. For example, the edit processing unit 105 may convert the data format of the editing data into the “JSON” format in response to the save instruction received from the terminal device T1, and may generate document data (an example of second document data) in the “DOCX” format to be the next version of the document to be supported.

The first control unit 107 may perform information communication with the terminal device T1 via the network. Specifically, the first control unit 107 may receive various instructions such as document data, a document review instruction, an editing instruction, and a save instruction transmitted from the terminal device T1. In addition, the first control unit 107 may transmit editing screen information (including information for executing the document editing process by the terminal device T1) to the terminal device T1. The first control unit 107 may receive information including the document data after the editing process from the terminal device T1.

The first control unit 107 of the present embodiment may generate layout information in the document review process and the document editing process. Here, the layout information in the document review process may be information for displaying the document review information generated by the document review process and the document to be supported with positionally associated with each other in a predetermined form on the browser screen of the terminal device T1. In addition, the layout information in the document editing process may be information for displaying the document review information generated by the document review process and the editing data generated by the document editing process in a predetermined form with positionally associated with each other on the browser screen of the terminal device T1.

Note that positionally associated with each other may refer to associating positions to be displayed so as to contribute to browsing by the user, and specifically may mean associating the positions on the screen, for example, in units of clauses, in units of paragraphs, and in units of sentences. Associating the positions may include, for example, displaying the corresponding portions closer in height or width direction than the other portions on the screen, and more preferably, displaying the corresponding portions side by side. Furthermore, in a case where the additional information may be displayed together, the layout information may include information for positionally associated the additional information with the document review information and the editing data. The layout information may be an example of the display control information.

The generation of the layout information may be performed by any method. For example, for a word or a phrase included in the document review information, the matching degree may be scored for each position (for example, each position in units of clauses or each position in units of paragraphs) in the editing data by the search function, and the layout information may be generated such that the document review information is displayed corresponding to the position with the highest score. Furthermore, for example, by allocating coordinates in units of clauses or units of paragraphs of the editing data and associating the coordinates with the corresponding document review information, it is also possible to associate the clauses and the paragraphs with the document review information in display position.

The first control unit 107 of the present embodiment may transmit various types of information such as document review information generated by the analysis unit 103, editing data generated by the edit processing unit 105, and layout information generated by the first control unit 107 in response to a request from the terminal device T1. In addition, the first control unit 107 may transmit editing screen information (including information for executing editing process by the terminal device T1) to the terminal device T1. The first control unit 107 may receive information including the document data after the editing process from the terminal device T1.

The first control unit 107 of the present embodiment may generate layout information in the document editing process. The layout information in the document editing process may be information for, for example, displaying the generated editing data in a predetermined form on the browser screen of the terminal device T1. Furthermore, the first control unit 107 of the present embodiment may generate layout information in the document review process. The layout information in the document review process may be information for, for example, displaying the document review information generated by the document review process and the document to be supported in a predetermined form on the browser screen of the terminal device T1.

In a case where the additional information is displayed together, the layout information may include information for positionally associated the additional information with the document review information and the editing data.

The first control unit 107 of the present embodiment may transmit various types of information such as document review information generated by an analysis unit 113, editing data generated by an edit processing unit 115, and layout information generated by the first control unit 107 in response to a request from the terminal device T1.

The storage unit 109 may store document data uploaded from the terminal device T1, document data of a new version generated from the editing data by the document editing process, additional information associated with each document data, and the like.

### Terminal Device T1

The terminal device T1 of the present embodiment may transmit and receive information about document display and document editing to and from the information processing device 10 in the document creation support service.

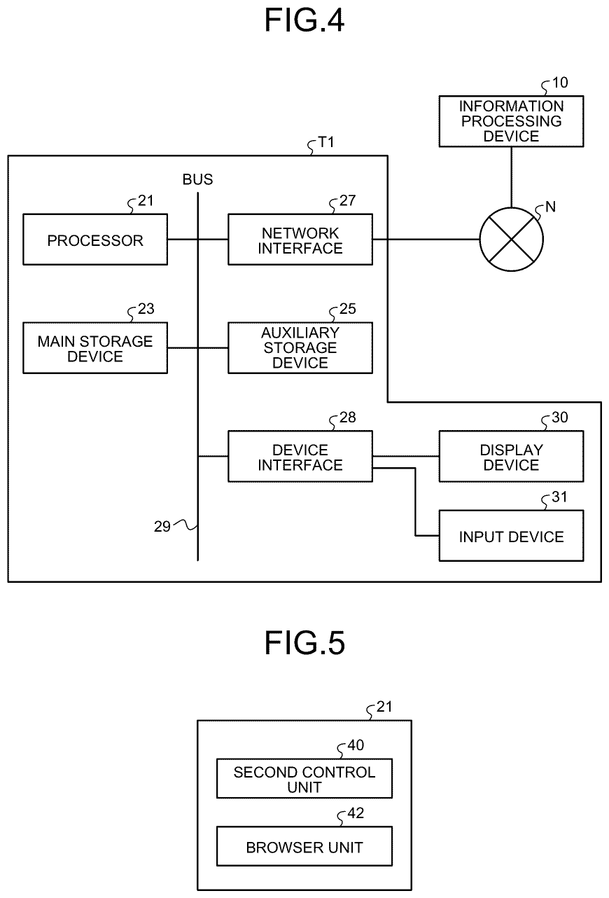

FIG. 4 is a block diagram illustrating an example of a hardware configuration of the terminal device T1 according to the embodiment. As illustrated in FIG. 4, the terminal device T1 may be a computer, and may include, as an example, a processor 21, a main storage device (memory) 23, an auxiliary storage device (memory) 25, a network interface 27, a device interface 28, a bus 29 connecting each component, a display device 30 connected to the device interface 28, and an input device 31 connected to the device interface 28. Note that specific hardware configurations of the processor 21, the main storage device 23, the auxiliary storage device 25, the network interface 27, the device interface 28, and the bus 29 may be similar to those of the processor 11, the main storage device 13, the auxiliary storage device 15, the network interface 17, the device interface 18, and the bus 19, respectively, and description thereof is omitted.

The display device 30 may be a display device such as a liquid crystal display (LCD), a cathode ray tube (CRT), a plasma display panel (PDP), or an organic electro luminescence (EL) panel. The display device 30 may display, for example, a document review screen and a document editing screen to be described later based on an instruction from the processor 21.

The input device 31 may be a device such as a keyboard, a mouse, or a touch panel. The user can input various editing instructions in the document editing process described later, for example, using the input device 31. The instruction input from the input device 31 may be transmitted to the processor 21.

Note that the terminal device T1 may include another external device (for example, a camera, a microphone, motion capture, various sensors, and the like) connected via the device interface 18 in order to operate and edit document data.

FIG. 5 is a diagram illustrating an example of functional blocks in the processor 21. The processor 21 may include, for example, a second control unit 40 and a browser unit 42 as functions implemented by the processor 21. The functions implemented by the second control unit 40 and the browser unit 42 may be stored as programs in, for example, the main storage device 23 or the auxiliary storage device 25. The processor 21 can implement functions related to the second control unit 40 and the browser unit 42 by reading and executing a program stored in the main storage device 23, the auxiliary storage device 25, or the like.

The second control unit 40 may activate the browser unit 42 in response to an instruction from the user.

The browser unit 42 may be, for example, a general web browser unit, and may execute processing according to hyper text markup language (HTML) data, a script (for example, JavaScript (registered trademark)), or the like. When activated, the browser unit 42 may transmit an initial access URL to the information processing device 10 for access.

The browser unit 42 of the present embodiment may display data including text data and image data received from the information processing device 10 on the display device 30 of the terminal device T1 in a predetermined form. More specifically, in the document review process, the browser unit 42 may display the document review information, the document data, the additional information, and the like received from the information processing device 10 on the display device 30 of the terminal device T1 in a predetermined form based on the layout information. Further, the browser unit 42 may receive editing screen information (including information for executing the document editing process) from the first control unit 107. Further, the browser unit 42 may receive editing screen information (including information for executing the editing process) from a first control unit 117 and may execute the editing process. In the document editing process, the browser unit 42 of the present embodiment may display the document review information, the editing data, the additional information, and the like received from the information processing device 10 on the display device 30 of the terminal device T1 in a predetermined form based on the layout information.

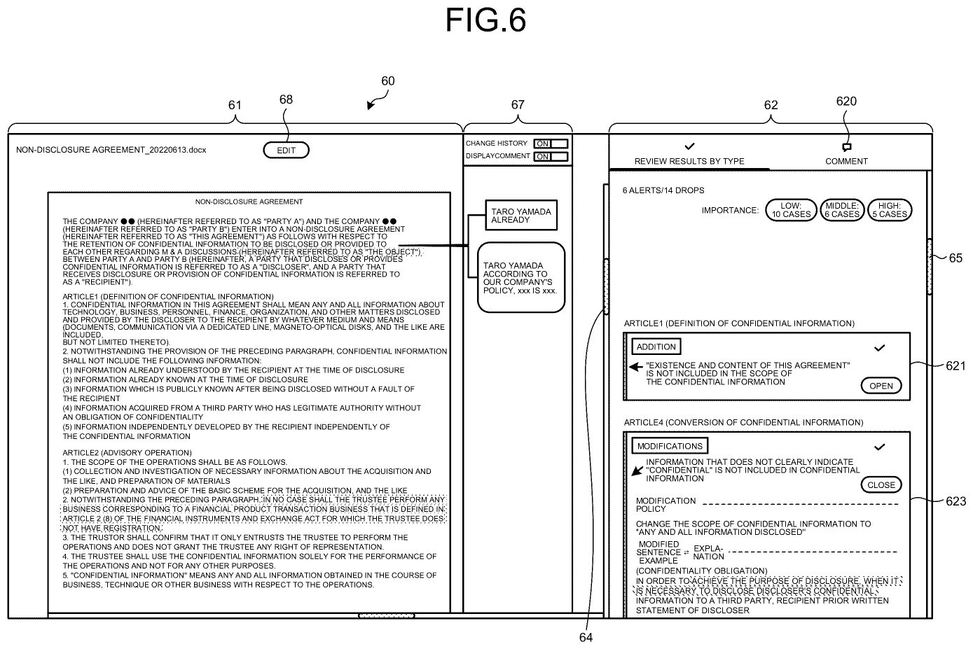

FIG. 6 is a diagram illustrating an example of a document review screen 60 displayed as a web browser screen on the display device 30 of the terminal device T1 in the document review process. As illustrated in FIG. 6, on the document review screen 60 of the present embodiment, the document to be supported may be displayed in a document display area 61, the additional information such as the change history and the comment is displayed in an additional information area 67, and the document review information is displayed in the document review area 62.

For example, an edit button 68 for instructing the start of the document editing process may be displayed in the document display area 61. Next to the additional information area 67 where the additional information is displayed, a scroll bar 64 for scrolling the document to be supported displayed in the document display area 61 and the additional information displayed in the additional information area 67 in the vertical direction may be displayed.

Furthermore, in the document review area 62 in which the document review information is displayed, a comment button 620 for instructing input of a comment as additional information, and comments 621 and 623 as document review information may be displayed so as to be positionally associated with the target clauses of the document to be supported.

More specifically, the comment 621 serving as the document review information for a certain clause of the document to be supported, which is “Article 1 (Definition of confidential information)” in the example of FIG. 6, may be displayed so as to be closer in the position in the screen height direction to “Article 1 (Definition of confidential information)” of the document to be supported than other clauses. In addition, the additional information (FIG. 6 illustrates a change history and a comment) may be also displayed so as to be positionally in the screen height direction associated with the target part “the object” of the document to be supported.

Note that the association of positions between the document to be supported displayed in the document display area 61, the additional information displayed in the additional information area 67, and the document review information displayed in the document review area 62 may be temporary. For example, in a state where the document to be supported, the additional information, and the document review information are not positionally associated with each other, and the document display area 61, the additional information area 67, and the document review area 62 are displayed, respectively, position association display between the document to be supported, the additional information, and the document review information may be executed in response to a predetermined operation such as inserting a cursor in a text of the document to be supported and clicking near the text with the position of the text as a reference. In addition, the position association display between the document to be supported, the additional information, and the document review information can be released by a predetermined operation.

Furthermore, in the document review screen 60 illustrated in FIG. 6, for example, in a case where the document to be supported (and the additional information displayed in the additional information area 67) displayed in the document display area 61 is scrolled in the vertical direction by the scroll bar 64, in conjunction with this, the document review information displayed in the document review area 62 may be also scrolled in the vertical direction while maintaining the display positional relationship with the document to be supported. Conversely, for example, in a case where the document review information displayed in the document review area 62 is scrolled in the vertical direction by a scroll bar 65, in conjunction with this, the document to be supported (and the additional information displayed in the additional information area 67) displayed in the document display area 61 may be also scrolled in the vertical direction while maintaining the display positional relationship with the document review information.

Furthermore, the document review information may include information indicating the level of importance of the review result. Furthermore, for example, as illustrated in the upper part of the document review area 62, the number of importance level of results pointed out may be indicated for each importance level.

While referring to the document review information and the additional information displayed on the document review screen, the user can easily consider what kind of pointed out items are in the document to be supported, how to modify, and the like.

Furthermore, as illustrated in FIG. 6, the edit button 68 for instructing the start of the document editing process may be displayed on the document review screen of the present embodiment. The user can start the document editing process by operating the edit button 68.

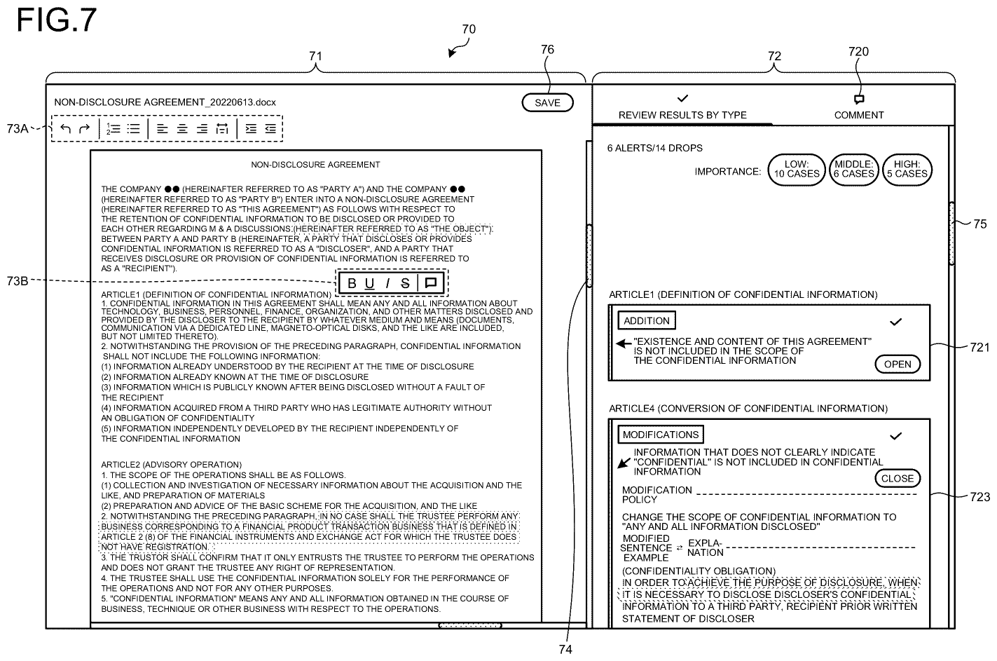

FIG. 7 is a diagram illustrating an example of a document editing screen 70 displayed as a web browser screen on the display device 30 of the terminal device T1 in the document editing process. In the document editing screen 70 illustrated in FIG. 7, for example, the web browser screen may be switched and displayed by operating the edit button 68 on the document review screen 60 illustrated in FIG. 6.

As illustrated in FIG. 7, on the document editing screen 70, the editing data may be displayed in a document editing area 71, and the document review information may be displayed in a document review area 72. Since the editing data displayed in the document editing area 71 of FIG. 7 is obtained by converting the data format of the document to be supported, the content thereof may be the same as that of the document to be supported displayed in the document display area 61 of FIG. 6. Furthermore, a comment button 720, comments 721 and 723 as the document review information, and a scroll bar 75 included in the document review area 72 may be the same as the comment button 620 and the like included in the document review area 62 of FIG. 6 because the content of the documents is similar. Note that, although FIG. 7 illustrates a case where the additional information is hidden, the additional information can be displayed in a form similar to FIG. 6, for example, by setting the document editing screen 70.

The user can edit the editing data by processing such as directly inputting, deleting, or pasting characters to the editing data displayed in the document editing area 71. Furthermore, on the document editing screen 70, tool bars 73A and 73B including buttons for inputting various editing instructions may be displayed in the document editing area 71 in which the editing data is displayed. The user can execute editing of the format of the editing data, character decoration, and comment insertion by operating a desired editing instruction button of the tool bars 73A and 73B.

In a case where a draft candidate that supports modification is displayed as the document review information in the document review area 72 of the document editing screen 70, the user can edit the editing data by adding the draft candidate to the editing data in the document editing area 71 by cut-and-paste processing or drag-and-drop processing.

Furthermore, in the document editing screen of the present embodiment, a save button 76 may be displayed in the document editing area 71 in which the editing data is displayed. The user can instruct to save the edited editing data by operating the save button 76. Note that the saving may be performed automatically in addition to the save instruction by the user. In addition, the saved data may be saved as another new version of the document to be supported, or may be overwritten and saved as the same version as the document to be supported.

### Flow of Document Creation Support Process

Next, an example of the document creation support process realized by the information processing device 10 according to the embodiment will be described. The document creation support process may include structure optimization processing in which a plurality of calculation algorithms is switched and used according to a situation.

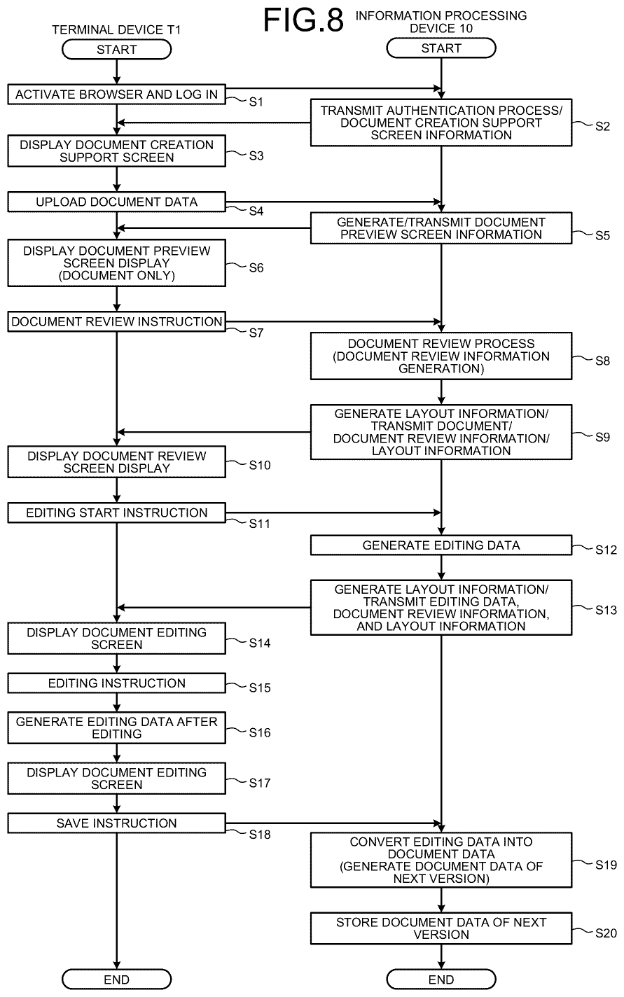

FIG. 8 is a flowchart illustrating a flow of the document creation support process according to the present embodiment. First, the second control unit 40 of the terminal device T1 may activate the browser unit 42 in response to an instruction from the user. The browser unit 42 of the terminal device T1 may transmit the login information such as the initial access URL and the registration ID to the information processing device 10 (Step S1).

The first control unit 107 of the information processing device 10 may execute the authentication process in response to the login information from the terminal device T1. In addition, the first control unit 107 may transmit the document creation support screen information generated by the first control unit 107 (Step S2).

The browser unit 42 of the terminal device T1 may display a document creation support screen on the display device 30 based on the document creation support screen information received from the information processing device 10 (Step S3).

The browser unit 42 of the terminal device T1 may transmit the document data to be supported data to the information processing device 10 in response to the document upload instruction from the user (Step S4). This upload instruction may be made by a user who gives a review instruction, or may be made by different users or/and terminals. For example, it may be performed by a terminal of a user of another department who requests the legal department to examine the contract document.

The first control unit 107 of the information processing device 10 may store the document data received from the terminal device T1 in the storage unit 109, and may generate document preview screen information based on the received document data. The first control unit 107 of the information processing device 10 may transmit the generated document preview screen information to the terminal device T1 (Step S5). Note that the document upload instruction and the saving of the document data in the first storage unit 109 may be performed by, for example, another user and/or another terminal of another department who requests the legal department to examine the contract document in advance of the editing processing.

The browser unit 42 of the terminal device T1 may display the document preview screen based on the document preview screen information received from the information processing device 10 (Step S6). At this stage, since it is before the document review process, for example, only the document to be supported may be displayed on the document preview screen. Note that the document creation support system S of the present embodiment can be used for browsing a document by executing Step S6.

The browser unit 42 of the terminal device T1 may transmit the document review instruction input from the user to the information processing device 10 (Step S7).

The analysis unit 103 of the information processing device 10 may execute the document review process in response to the document review instruction from the terminal device T1, and may generate document review information (Step S8).

The first control unit 107 of the information processing device 10 may generate layout information for displaying the document review information in association with the document to be supported. The first control unit 107 of the information processing device 10 may transmit the document data of the document to be supported, the document review information generated by the analysis unit 103, and the layout information generated by the first control unit 107 to the terminal device T1 (Step S9).

The browser unit 42 of the terminal device T1 may display the document review screen based on the document data, the document review information, and the layout information received from the information processing device 10 (Step S10). Note that, on this document review screen, for example, the document review information and the document as illustrated in FIG. 6 may be displayed in a form in which they are positionally associated with each other.

The browser unit 42 of the terminal device T1 may transmit an editing start instruction (for example, an instruction by the operation of the edit button 68 illustrated in FIG. 7) input by the user to the information processing device 10 (Step S11).

In response to the editing start instruction from the terminal device T1, the edit processing unit 105 of the information processing device 10 may convert the data format of the document data and generate editing data (Step S12).

The first control unit 107 of the information processing device 10 may generate layout information for displaying the editing data and the document review information in association with each other. The first control unit 107 of the information processing device 10 may transmit the editing data, the document review information, the layout information, and the information for executing the document editing process to the terminal device T1 (Step S13).

The browser unit 42 of the terminal device T1 may display the document editing screen based on the editing data, the document review information, the layout information, and the information for executing the document editing process received from the information processing device 10 (Step S14). Note that, on this document editing screen, for example, the document review information and the editing data as illustrated in FIG. 7 may be displayed in a form in which they are positionally associated with each other.

The browser unit 42 of the terminal device T1 may receive various editing instructions (for example, operation of edit buttons of tool bars 63A and 63B illustrated in FIG. 7, an instruction by inputting text data, and the like) input from the user (Step S15).

The browser unit 42 of the terminal device T1 may generate editing data reflecting the editing instruction in response to the editing instruction (Step S16).

The browser unit 42 of the terminal device T1 may display the document editing screen based on the editing data after the information document editing process, the document review information, and the layout information (Step S17).

The browser unit 42 of the terminal device T1 may transmit a save instruction (for example, an instruction by the operation of a save button 66 illustrated in FIG. 7) input by the user to the information processing device 10 (Step S18). At this time, information about the editing data after the document editing process may be also transmitted.

The edit processing unit 105 of the information processing device 10 may convert the data format of the editing data in response to the editing start instruction from the terminal device T1, and may generate the document data (that is, document data of a new version in the format same as that of the document uploaded in Step S4) of the next version (Step S19).

The editing data subjected to the editing processing may be saved by overwriting the document data to be supported data uploaded in Step S4, or may be saved as another data (for example, data having a different version).

In addition, a URL that can access the edited document data may be issued without performing the document data download processing. In addition, the terminal device to which the data is to be downloaded may be a terminal device different from the terminal device that executed edition, and the download may be performed by a user of another department who requests the legal department to examine the contract document or a contract document negotiation counterpart.

The edit processing unit 105 of the information processing device 10 may store the document data for storage in the storage unit 109 (Step S20).

The information processing device 10 according to the present embodiment may include at least one memory and at least one processor. The at least one processor may transmit, to the terminal device T1, an instruction to display the document data of the document to be supported as the stored first document data and the document review information as the analysis information of the document data with positionally associated with each other on the terminal device T1, may generate editing data based on the document data, and may edit the editing data in response to the editing instruction received from the terminal device T1.

Therefore, for example, it is possible to realize an online editor that operates on a browser capable of editing the contract document body in a state where the contract document body and the document review result of the contract document are displayed side by side. As a result, when document creation is supported on the web browser, it is possible to realize a technique in which a user's operation burden is lighter and convenience is higher than before.

In addition, the edit processing unit 105 of the information processing device 10 may generate and store second document data having the data format same as that of the document to be supported as the first document data based on the edited editing data.

Therefore, the document edited while referring to the document review information on the web browser can be saved and managed in the data format same as that of the document to be supported.

Furthermore, the first control unit 107 of the information processing device 10 may generate display control information (layout information) that displays the editing data or the edited editing data and the document review information as the analysis information with positionally associated with each other. The first control unit 107 of the information processing device 10 may transmit the layout information together with the editing data and the document review information to the terminal device T1.

Therefore, on the terminal device T1, the editing data and the document review information can be displayed with positionally associated with each other based on the layout information. The user can edit the editing data while referring to, for example, the document review information displayed with positionally associated with the editing data.

In addition, the document review information as the analysis information may include a modified sentence example of at least part of the document to be supported as the first document data. The edit processing unit 105 of the information processing device 10 may edit the editing data in response to the editing instruction based on the modified sentence example.

Therefore, the user can input an editing instruction for the editing data by, for example, a drag and drop operation on a desired modified sentence example while referring to the modified sentence example presented as the document review information.

The first document data may be document data related to a legal document. The analysis unit 103 of the information processing device 10 may generate the document review information as the analysis information by analyzing the first document data based on the standard of the legal document to which the first document data belongs. Further, the legal document may be document data related to a contract. The analysis unit 103 of the information processing device 10 can generate a modified sentence example according to a party to the contract. Note that the generation of the modified sentence example may be performed by a learned model such as a large language model (LLM). The modified sentence example may be acquired by communicating with a server outside the system including a generatable learned model capable of generating the modified sentence example.

Furthermore, the information processing device 10 may transmit an instruction to cause the terminal device T1 to display the generated editing data or the edited editing data and the document review information as the analysis information with positionally associated with each other in units of clauses or units of paragraphs.

Therefore, on the terminal device T1, it is possible to display the editing data and the document review information based on the layout information with positionally associated with each other in units of clauses or units of paragraphs. The user can edit the editing data while referring to, for example, the document review information displayed with positionally associated with the editing data in units of clauses or in units of paragraphs.

Furthermore, the analysis unit 103 of the information processing device 10 may execute the analysis process on the edited editing data to generate document review information as new analysis information. The first control unit 107 of the information processing device 10 may transmit the generated new document review information to the terminal device T1.

Therefore, on the terminal device T1, the edited editing data can be reviewed and further edited while referring to the document review information as new analysis information.

Furthermore, the edit processing unit 105 of the information processing device 10 may store the second document data as a next version of the first document data.

Therefore, the document edited while referring to the document review information on the web browser can be managed as the next version of the document to be supported.

### First Modification

In the document creation support process, it is also possible to execute document review again using edited editing data. In this case, for example, the second document data may be displayed in Step S6, and a button for instructing the review is operated in Step S7, and the document review of the second document data may be executed.

In addition, document review of document data may be executed on the document being edited. That is, the review processing may be performed again during document editing, and the displayed review result may be updated. For example, processing corresponding to Steps S8 to S10 may be executed by providing a button for instructing “document review” on the document editing screen of Step S18 and operating the button. In addition, the document automatically edited according to the document editing processing may be reviewed. As a result, the user can grasp whether the editing is appropriate while editing, and can efficiently edit the document. In addition, an instruction to start editing may be given without displaying the document preview screen, and editing of the document may be started. For example, a list of names of editable documents in the list may be displayed, and the instruction to start editing may be given by operating the name by clicking or the like.

### Second Modification

In the above embodiment, the document data, the additional information, and the document review information may be set as data of different files, and managed in association with each other. On the other hand, data including the document data, the additional information, and the document review information may be managed as one file.

### Third Modification

In the above-described embodiment, the editing processing is executed by the user terminal T1, but may be executed by the information processing device. Furthermore, although the editing processing is performed in response to the user's instruction, the editing processing may be automatically performed, for example, by the information processing device or the user terminal T1 without being based on the user's instruction. In addition, the information processing device 10 may convert the data format of the document data into, for example, the JSON format in response to the editing start instruction from the terminal device T1, but the conversion of this format may be performed at a timing when editing can be performed.

### Fourth Modification

In the above embodiment, the flow of the editing processing including the preview screen display of the document to be supported is described as an example. However, the preview screen display of the document to be supported may be omitted, and the editing process may be executed immediately after the user receives the editing data.

### Fifth Modification

Some or all of the devices in the above-described embodiments may be configured by hardware, or may be configured by information processing of software (program) executed by a CPU, a GPU, or the like. In the above embodiment, when a plurality of storage devices stores data, each of the plurality of storage devices may store only part of the data or may store the entire data.

As described above, the information processing device according to the embodiment may include at least one memory and at least one processor. The at least one processor may transmit, to a terminal device, an instruction to cause the terminal device to display stored first document data and review information of the first document data with positionally associated with each other, may generate editing data based on the first document data, and may edit the editing data in response to an editing instruction received from the terminal device.

Furthermore, an information processing device according to another embodiment may include at least one memory and at least one processor. The at least one processor may execute a review process on first document data to generate review information, may receive an editing start instruction from a terminal device that displays the first document data and the review information side by side with positionally associated with each other, may generate editing data based on the first document data in response to the editing start instruction, may edit the editing data in response to the editing instruction received from the terminal device by the receiver, and may transmit the edited editing data and the review information to the terminal device.

The information processing device may generate second document data having the data format same as that of the first document data based on the edited editing data.

The information processing device may transmit, to the terminal device, display control information for displaying the editing data or the edited editing data and the review information with positionally associated with each other.

In the information processing device, the review information may include a modified sentence example of at least part of the first document data, and the editing may include editing the editing data in response to the editing instruction based on the modified sentence example.

In the information processing device, the first document data may be document data related to a legal document, and the review information may be information obtained by reviewing the first document data based on a standard of the legal document to which the first document data belongs.

In the information processing device, the legal document may be document data related to a contract, and the at least one processor may generate the modified sentence example according to a party to the contract.

In the information processing device, the at least one processor may transmit an instruction to cause the terminal device to display the generated editing data or the edited editing data and the review information with positionally associated each other in units of clauses or units of paragraphs.

In the information processing device, the at least one processor may execute a review process on the edited editing data to generate new review information, and transmit the generated new review information to the terminal device.

In the information processing device, the editing data may be a JSON file, and the first document data and the second document data may be DOCX files.

In the information processing device, the editing data may include format information different from format information of the first document data, and the second document data may include format information based on the first document data.

In the information processing device, the at least one processor may store the second document data as a next version of the first document data.

An information processing program according to an embodiment may cause a computer to implement a function of transmitting, to a terminal device, an instruction to cause the terminal device to display first document data and review information of the first document data with positionally associated with each other, a function of generating editing data based on the first document data, and a function of editing the editing data in response to an editing instruction received from the terminal device.

An information processing method according to an embodiment may include transmitting, to a terminal device, an instruction to cause the terminal device to display first document data and review information of the first document data with positionally associated with each other, generating editing data based on the first document data, and editing the editing data in response to an editing instruction received from the terminal device.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising
at least one processor, wherein
the at least one processor is configured to:
transmit, to a terminal device, an instruction to cause the terminal device to display first document data that has been saved and review information of the first document data with positionally associated with each other;
generate editing data based on the first document data; and
edit the editing data in response to an editing instruction received from the terminal device.

2. The information processing device according to claim 1, wherein
the at least one processor is configured to generate second document data having a data format identical to a data format of the first document data, based on the edited editing data.

3. The information processing device according to claim 1, wherein
the at least one processor is configured to transmit, to the terminal device, display control information for displaying the editing data or the edited editing data and the review information with positionally associated with each other.

4. The information processing device according to claim 1, wherein
the review information includes a modified sentence example of at least part of the first document data, and
the editing data is edited in response to the editing instruction based on the modified sentence example.

5. The information processing device according to claim 4, wherein
the first document data is legal document data related to a contract, and
the modified sentence example is generated according to a party to the contract.

6. The information processing device according to claim 1, wherein
the first document data is document data related to a legal document, and
the review information is information obtained by reviewing the first document data based on a standard of a legal document to which the first document data belongs.

7. The information processing device according to claim 1, wherein
the at least one processor is configured to transmit an instruction to cause the terminal device to display the generated editing data or the edited editing data and the review information with positionally associated with each other in units of clauses or in units of paragraphs.

8. The information processing device according to claim 1, wherein
the at least one processor is configured to:
execute a review process on the edited editing data to generate new review information; and
transmit the generated new review information to the terminal device.

9. The information processing device according to claim 2, wherein
the editing data is a JSON file, and the first document data and the second document data are DOCX files.

10. The information processing device according to claim 2, wherein
the editing data includes format information different from the first document data, and the second document data includes format information based on the first document data.

11. The information processing device according to claim 2, wherein
the second document data is stored as a next version of the first document data.

12. A non-transitory computer-readable medium storing a program including instructions that, when executed by a computer, cause the computer to perform:
transmitting, to a terminal device, an instruction to cause the terminal device to display first document data that has been saved and review information of the first document data with positionally associated with each other;
generating editing data based on the first document data; and
editing the editing data in response to an editing instruction received from the terminal device.

13. An information processing method comprising:
transmitting, to a terminal device, an instruction to cause the terminal device to display first document data that has been saved and review information of the first document data with positionally associated with each other;
generating editing data based on the first document data; and
editing the editing data in response to an editing instruction received from the terminal device.
